(19) United States
(12) Patent Application Publication
(10) Pub. No.: US 2016/0188227 A1
(43) Pub. Date: Jun. 30, 2016

(54) METHOD AND APPARATUS FOR WRITING DATA INTO SOLID STATE DISK

(71) Applicant: SAMSUNG ELECTRONICS CO., LTD., Suwon-si (KR)

(72) Inventors: FEI YANG, Xl'AN (CN); KUN DOU, XI'AN (CN); SIYU CHEN, XI'AN (CN); HAIBO TANG, XI'AN (CN); NA LI, XI'AN (CN); MENGWEI HOU, XI'AN (CN); MINGLI DUAN, XI'AN (CN)

(21) Appl. No.: 14/979,744

(22) Filed: Dec. 28, 2015

(30) Foreign Application Priority Data
Dec. 25, 2014 (CN) 201410768099.X

(51) Int. Cl. G06F 3/06

(52) U.S. Cl. CPC G06F 3/0616; G06F 3/064; G06F 3/0673

(57) ABSTRACT

A method for writing data into a solid state disk (SSD) includes determining lifecycle information of data to be written, determining a lifecycle group of the data to be written based on the lifecycle information of the data to be written, and writing the data to be written into the SSD based on the lifecycle group of the data to be written.

This application claims priority under 35 U.S.C. §119 to Chinese Patent Application No. 201410768099.X, filed on Dec. 25, 2014, in the Chinese Intellectual Property Office, the disclosure of which is incorporated by reference herein in its entirety.

### TECHNICAL FIELD

The present inventive concept relates to writing data, and more particularly, to a method and apparatus for writing data into a solid state disk (SSD).

### DISCUSSION OF THE RELATED ART

Generally, a solid state disk (SSD) includes a control unit and a storage unit (e.g., a flash chip). The control unit reads and writes data and the storage unit stores data. A storage system can complete an input/output (I/O) operation on a storage unit in an arbitrary location within a short time because the SSD is not a mechanical device such as a common hard disk.

An SSD control unit may include a flash translation layer, wear leveling, garbage collection, a reserved space, a Trim instruction, writing amplification, bad block management, error check and correction, and the like. The garbage collection, which combines valid data in all blocks into a new block and erases an old block, is a function of the SSD. The garbage collection may be capable of reducing an addressing load and reserving more free blocks.

However, when performing the garbage collection on the SSD, valid data may need to be moved because both the valid data and invalid data may simultaneously exist in one block. Moving large amount of valid data may result in wear and performance reduction of the SSD.

### SUMMARY

According to an exemplary embodiment of the present inventive concept, a method for writing data into a solid state disk (SSD) includes determining lifecycle information of data to be written, determining a lifecycle group of the data to be written based on the lifecycle information of the data to be written, and writing the data to be written into the SSD based on the lifecycle group of the data to be written.

In an exemplary embodiment of the present inventive concept, the SSD includes a plurality of blocks that correspond to a plurality of lifecycle groups. Writing the data to be written into the SSD includes writing the data to be written into a block of the SSD that corresponds to the lifecycle group of the data to be written into the SSD.

In an exemplary embodiment of the present inventive concept, when there are a plurality of data to be written into the SSD, writing the data to be written into the SSD includes sequentially and successively writing the data having a same lifecycle group, from among the plurality of data to be written into the SSD.

In an exemplary embodiment of the present inventive concept, Step (C) includes: writing sequentially the data to be written belonging to the same lifecycle group successively into the SSD, when there are a plurality of data to be written.

In an exemplary embodiment of the present inventive concept, writing the data to be written into the SSD includes determining whether the lifecycle group of the data to be written into a block of the SSD to be currently written into is identical to the lifecycle group of the data which are stored in the block of the SSD to be currently written into. When the lifecycle of the data to be written into the block of the SSD to be currently written into is identical to the lifecycle group of the data which is stored in the block of the SSD to be currently written into, the data to be written into the block of the SSD to be currently written into is written by beginning from a location to be written into of the block of the SSD to be currently written into. The data to be written is held in a writing suspend state when the lifecycle group of the data to be written in the block of the SSD to be currently written into is different from the lifecycle group of the data which are stored in the block of the SSD to be currently written into.

In an exemplary embodiment of the present inventive concept, writing the data to be written into the SSD further includes detecting whether there are new data to be written into the SSD which are waiting to be written into the SSD after writing the data to be written into the SSD. When there are new data to be written which are waiting to be written into the SSD, a lifecycle information of the new data to be written into the SSD is determined. When there are no new data to be written which are waiting to be written into the SSD, all the data to be written into the SSD which are held in the writing suspend state are written into the SSD beginning from a location to be written into of a block to be currently written into.

In an exemplary embodiment of the present inventive concept, the data to be written into the SSD having a same lifecycle group, from among all the data to be written into the SSD which are held in the writing suspend state, are sequentially and successively written into the SSD during a process of writing all the data to be written into the SSD which are held in the writing suspend state by beginning from the location to be written into of the block to be currently written into.

In an exemplary embodiment of the present inventive concept, the data to be written into the SSD are in a form of a file, and wherein writing the data to be written into the SSD further includes detecting whether there are data currently being written into the SSD. When there are no data currently being written into the SSD, it is determined whether the lifecycle group of the data to be written into the block of the SSD to be currently written into is identical to the lifecycle group of the data which is stored in the block of the SSD to be currently written into.

In an exemplary embodiment of the present inventive concept, the lifecycle information of the data to be written into the SSD indicates a lifecycle length or a deletion time of the data to be written into the SSD.

In an exemplary embodiment of the present inventive concept, the data to be written into the SSD of which the deletion time is in a same garbage collection cycle are grouped in a same lifecycle group.

In an exemplary embodiment of the present inventive concept, the data to be written into the SSD having a same or similar lifecycle information are grouped in a same lifecycle group.

According to an exemplary embodiment of the present inventive concept, an apparatus for writing data into an SSD a lifecycle information determining unit to determine lifecycle information of data to be written into the SSD. A lifecycle group determining unit determines a lifecycle group of the data to be written into the SSD according to the lifecycle information of the data to be written into the SSD. A data writing unit writes the data to be written into the SSD according to the lifecycle group of the data to be written into the SSD.

In an exemplary embodiment of the present inventive concept, a plurality of blocks of the SSD correspond to a plurality of lifecycle groups of the data to be written in the SSD. The data writing unit writes the data to be written into the SSD into a block of the SSD, from among the plurality of blocks of the SSD, that corresponds to the lifecycle group of the data to be written into the SSD.

In an exemplary embodiment of the present inventive concept, when there are a plurality of data to be written into the SSD, the data writing unit writes into the SSD the data to be written that are grouped in a same lifecycle group sequentially and successively.

In an exemplary embodiment of the present inventive concept, the data writing unit includes a determining unit to determine whether the lifecycle group of the data to be written into a block of the SSD to be currently written into is identical to the lifecycle group of the data which are stored into the block of the SSD to be currently written into. A writing unit writes the data to be written into the SSD by beginning from a location to be written into of the block of the SSD to be currently written into, when the lifecycle group of the data to be written into the SSD is identical to the lifecycle group of the data which are stored into the block of the SSD to be currently written into. A suspending unit holds the data to be written in a writing suspend state when the lifecycle group of the data to be written into the block of the SSD to be currently written into is different from the lifecycle group of the data which are stored into the block of the SSD to be currently written into.

In an exemplary embodiment of the present inventive concept, the data writing unit further includes a first detecting unit to detect whether there currently are new data to be written which are waiting to be written into the SSD after holding the data to be written in the writing suspend state. When there currently are new data to be written which are waiting to be written into the SSD, the lifecycle information determining unit determines a lifecycle information of the new data to be written. When there currently are no new data to be written which are waiting to be written into the SSD, the writing unit writes all the data to be written into the SSD which are held in the writing suspend state by beginning from a location to be written into of a block to be currently written into.

In an exemplary embodiment of the present inventive concept, during a writing process, the writing unit sequentially and successively writes into the SSD the data to be written into the SSD which are grouped in a same lifecycle group, among all the data to be written into the SSD which are held in the writing suspend state, by beginning from the location to be written into of the block to be currently written into.

In an exemplary embodiment of the present inventive concept, the data to be written into the SSD are in a form of a file, and wherein the data writing unit further includes a second detecting unit to detect whether there are data currently being written into the SSD. When there are no data currently being written into the SSD, the determining unit determines whether the lifecycle group of the data to be written into the SSD is identical to the lifecycle group of the data which are stored into the block of the SSD to be currently written into.

In an exemplary embodiment of the present inventive concept, the lifecycle information of the data to be written into the SSD indicates a lifecycle length or a deletion time of the data to be written into the SSD.

In an exemplary embodiment of the present inventive concept, the data to be written in the SSD of which the deletion time is in a same garbage collection cycle are grouped in a same lifecycle group.

In an exemplary embodiment of the present inventive concept, the data to be written into the SSD having the same or similar lifecycle information belong to a same lifecycle group.

According to an exemplary embodiment of the present inventive concept, an apparatus for writing data into an SSD includes a lifecycle information determining unit, a lifecycle group determining unit, and a data writing unit. The lifecycle information determining unit determines lifecycle information of a first data to be written into the SSD, and a lifecycle information of a second data to be written into the SSD. The lifecycle group determining unit determines a lifecycle group of the first data to be written into the SSD based on the lifecycle information of the first data to be written into the SSD, and a lifecycle group of the second data to be written into the SSD based on the lifecycle information of the second data to be written into the SSD. The data writing unit writes the first data to be written into the SSD based on the lifecycle group of the first data to be written into the SSD, and the second data to be written into the SSD based on the lifecycle group of the second data to be written into the SSD. The lifecycle information of the first data to be written into the SSD is information that indicates a storage time length of the first data to be written into the SSD or a deletion time of the first data to be written into the SSD. The lifecycle information of the second data to be written into the SSD is information that indicates a storage time length of the second data to be written into the SSD or a deletion time of the second data to be written into the SSD.

In an exemplary embodiment of the present inventive concept, the lifecycle information of the first data to be written into the SSD is determined based on a type, utility, source, or information of an object indicated by the first data to be written into the SSD, and the lifecycle information of the second data to be written into the SSD is determined based on a type, utility, source, or information of an object indicated by the second data to be written into the SSD.

In an exemplary embodiment of the present inventive concept, when the first and second data to be written into the SSD are grouped in a same lifecycle group, the first and second data to be written into the SSD are written consecutively into the SSD.

In an exemplary embodiment of the present inventive concept, the data writing unit further includes a suspending unit. When data stored in a block of the SSD to be currently written is grouped into a lifecycle group that is different from the lifecycle group into which the first data to be written into the SSD is grouped but identical to the lifecycle group in which the second data to be written into the SSD is grouped, the first data to be written into the SSD is held in a writing suspend state by the suspending unit and the second data to be written into the SSD is written into the block of the SSD to be currently written into.

In an exemplary embodiment of the present inventive concept, the data writing unit further includes a first detecting unit to detect whether there currently are new data to be written which are waiting to be written into the SSD after holding the first data in the writing suspend state. When there currently are new data to be written which are waiting to be written into the SSD, the lifecycle information determining unit determines a lifecycle information of the new data to be written. When there currently are no new data to be written which are waiting to be written into the SSD, the writing unit writes the first data into the SSD by beginning from a location to be written into of a block to be currently written into.

In an exemplary embodiment of the present inventive concept, the first and second data to be written into the SSD are data of a same file, and the first and second data to be written into the SSD are written in a same block of the SSD.

### BRIEF DESCRIPTION OF THE DRAWINGS

The above and other aspects and features of the present inventive concept will become more apparent by describing in detail exemplary embodiments of the inventive concept with reference to the following figures, in which:

FIG. 1 illustrates a flowchart of a method for writing data into a solid state drive (SSD), according to an exemplary embodiment of the present inventive concept;

FIG. 2 illustrates a flowchart of a method for writing data to be written into an SSD, according to an exemplary embodiment of the present inventive concept;

FIG. 3 illustrates a block diagram of an apparatus for writing data into an SSD, according to an exemplary embodiment of the present inventive concept; and

FIG. 4 illustrates a block diagram of a data writing unit, according to an exemplary embodiment of the present inventive concept.

### DETAILED DESCRIPTION OF THE EMBODIMENTS

Exemplary embodiments of the inventive concept will now be described in detail with reference to the accompanying drawings. The inventive concept may, however, be embodied in various different forms, and should not be construed as being limited to the illustrated exemplary embodiments. Like reference numerals may denote like elements throughout the specification. In the drawings, the sizes and relative sizes of layers and regions may be exaggerated for clarity.

As used herein, the singular forms “a”, “an” and “the” are intended to include the plural forms as well, unless the context clearly indicates otherwise. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it may be directly on, connected, coupled, or adjacent to the other element or layer, or intervening elements or layers may be present.

Unless otherwise defined, all terms, including technical and scientific terms, used herein have the same meaning as commonly understood by one of ordinary skill in the art. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

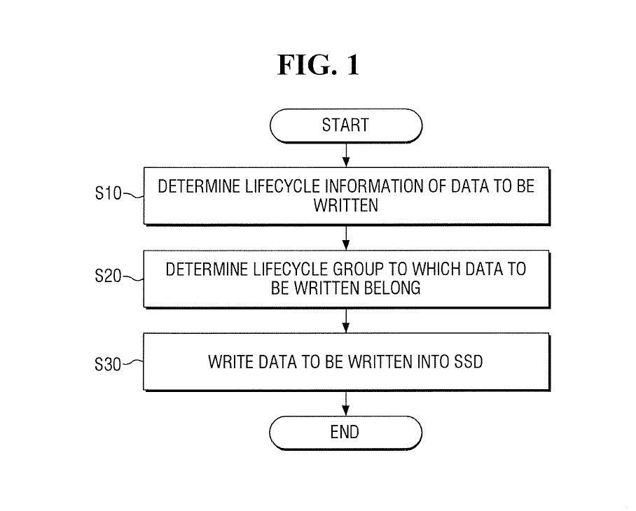

FIG. 1 illustrates a flowchart of a method for writing data into a solid state drive (SSD), according to an exemplary embodiment of the present inventive concept.

As shown in FIG. 1, in Step S10, lifecycle information of data to be written is determined. Here, the data to be written may exist in a form of a data unit, for example a file, a field, a byte, a bit, and other data having various data structures. The inventive concept is not limited to the above-referenced data units and may include other data units in addition to the above-referenced data units. The lifecycle information is information which may indicate a lifecycle length of the data (e.g., a storage time length) or a deletion time of the data. In an exemplary embodiment of the inventive concept, the lifecycle information indicates a storage time length of the data. In an exemplary embodiment of the inventive concept, the lifecycle information indicates the deletion time of the data. The lifecycle information of the data may be determined according to a data characteristic.

For example, some applications or systems may need to periodically update or delete data. The lifecycle information of these data may be quantitatively determined.

In addition, the lifecycle information of the data may be determined according to a logical storage unit of the data in the SSD. For example, when the logical storage unit is a file, the data belonging to the same file have the same lifecycle information. Accordingly, if a first data and a second data belong to the same file, then it may be determined that the lifecycle information of the first and second data is identical.

In addition, statistics or a training of various combination relationships between the lifecycle information of the data and an attribute of the data, for example, a type of the data, a utility of data, a source of the data, and the like, may be conducted. Accordingly, it may be possible to qualitatively determine the lifecycle information of the data by using the attributes of the data. The statistics or training of the various combination relationships between the lifecycle information of the data and the attributes of the data may be implemented in cases when a usage scene of the SSD is relatively fixed or repeated.

It should be understood that the lifecycle information of the data may be obtained in various ways. The present inventive concept is not limited to the above-referenced ways of obtaining the lifecycle information of data.

In an exemplary embodiment of the inventive concept, level information of data in a RocksDB system may be used to determine the lifecycle information of the data. For example, in an exemplary embodiment of the inventive concept, the level information of data in the RocksDB system is the lifecycle information of the data. In the RocksDB system, when performing a level compaction, the level compaction is implemented by combining data in two adjacent levels. This is so because the combination involves an operation on most of the data in a level. The data in the same level have the same or similar lifecycle. Most of the data stored in each level have the same or similar deletion time. The deletion time of most of the data stored in a particular level may be obtained by conducting statistics on a generation time and a deletion time of the data stored in the particular level. Therefore, it may be determined that a first data and a second data have the same or similar deletion time when the information of the first and second data indicates that the first and second data belong to the same level. In an exemplary embodiment of the inventive concept, a data type of data in a Cassandra system may be used to determine the lifecycle information of the data. In the Cassandra system, most of the data belong to one of the following three data types: metadata, a log file, and an SST file. The metadata may be frequently updated and may be modified during each database operation. Accordingly, the lifecycle of the metadata may be short. The log file exists for database reliability and may then be deleted after the data are regularly fixed into the SSD from a memory through a storage system. Accordingly, the lifecycle of the data in the log file may be intermediate. An SST file may be used for placement of real data. Accordingly, a lifecycle of the SST file may be long.

In an exemplary embodiment of the inventive concept, information of an object indicated by the data can be used as the lifecycle information of the data. Because the object indicated by the data generally corresponds to a lifecycle length or a deletion time of the data, the lifecycle information of the data may be acquired according to the object indicated by the data. For example, in a storage system for a game management system, when an object indicated by the data is a user ID, user registration information, and the like, and the data may not be updated once created, the lifecycle of data indicating this object is long. When an object indicated by the data is experience of the game player, money of the game player, and the like, the lifecycle of the data indicating this object is short because these data are associated with each game operation and are updated frequently. When an object indicated by the data is a user ranking, and the like, the data may need to be updated hourly or daily. Accordingly, the lifecycle of the data indicating this object is intermediate.

In an exemplary embodiment of the inventive concept, information indicating a source of data may be used to determine the lifecycle information of the data. The lifecycle information of the data may be determined based on the source of the data. In a cloud storage system, for example, data may be divided into data uploaded by a user and internal management data, according to the source of the data. The internal management data, for example, include an index, a distribution path, and the like, and are associated with operations of all users and are frequently updated. Therefore, it may be determined that the lifecycle of the internal management data is short. When the data uploaded by the user are associated only with the user and are infrequently modified by the user, it may be determined that the lifecycle of the data uploaded by the user is long. Alternatively, a lifecycle of data stored by a respective user may be predicted according to operation habits of the user. For example, when the user is accustomed to not modifying the data for a long time after uploading the data, it may be determined that the lifecycles of all the data uploaded by the user are long. When the user is accustomed to frequently modify the data, delete the data, or the like, after uploading the data, it may be determined that the lifecycles of all the data uploaded by the user are short.

It should be understood that other information which can be used to indicate a lifecycle length or a deletion time of data may be used as the lifecycle information of the data. The inventive concept is not limited to the above-referenced ways to determine the lifecycle information of data to be written.

In Step S20, a lifecycle group of the data to be written is determined according to the lifecycle information of the data to be written.

Here, data that have the same or similar lifecycle information belong to the same lifecycle group. For example, data that have the same or similar lifecycle information are grouped in the same lifecycle group.

For example, when the lifecycle information includes level information of data in a RocksDB system, data that have the same level information are grouped in the same lifecycle group. When the lifecycle information is a data type of the data in a Cassandra system, the data that are of the same data type (e.g., the metadata, the log file, the SST, and the like) are grouped in the same lifecycle group. When the lifecycle information is information of an object indicated by the data, the data that indicate the same object are grouped the same lifecycle group. When the lifecycle information is the source of the data, the data that come from the same source are grouped in the same lifecycle group.

In addition, when the lifecycle information indicates deletion time, the data of which the deletion time is in the same garbage collection cycle are grouped in the same lifecycle group.

In Step S30, data to be written are written into the SSD according to the lifecycle group in which the data to be written are grouped. For example, a writing sequence of the data to be written into the SSD is determined by considering the lifecycle group in which the data to be written are grouped.

In an exemplary embodiment of the inventive concept, an SSD may include a plurality of blocks. Each block, from among the plurality of blocks of the SSD, may correspond to a particular lifecycle group. When performing Step S30, the data to be written is written into a block of the SSD that corresponds to the lifecycle group of the data to be written. For example, a block of the SSD may to correspond to a first lifecycle group. The first lifecycle group may be, for example, a group for data having a short lifecycle. Data to be written may be grouped into a first group. The first group may be, for example, a group of data that is determined to have a short lifecycle. Accordingly, that data to be written that is grouped into the first group may be written into the first block. This is done to write (e.g., store) data having a same lifecycle group in the same block. In addition, the data stored in the same block have the same or similar lifecycle length and/or the same or similar deletion time.

In an exemplary embodiment of the inventive concept, when there is a plurality of data to be written, the data that is grouped into the same lifecycle group may be sequentially and successively written into the same block of the SSD. This is done to store as much data that is grouped in the same lifecycle group as possible into the same block of the SSD. For example, when being written, the data that are grouped in the same lifecycle group may be arranged together and written into the SSD sequentially.

A plurality of data to be written may be sorted according to the lifecycle group in which they are grouped. For example, data grouped in a first lifecycle group may be sorted first, data belonging to a second lifecycle group may be sorted second, data belonging to a third lifecycle group may be sorted third, and the like. The data to be written is then sequentially and successively written into the SSD in the sorted order.

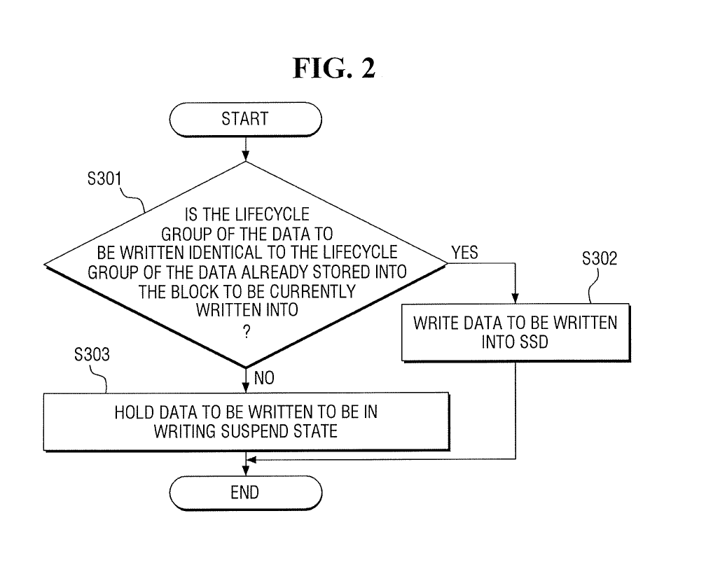

FIG. 2 illustrates a flowchart of a method for writing data to be written into an SSD, according to an exemplary embodiment of the present inventive concept.

As shown in FIG. 2, in Step S301, it is determined whether the lifecycle group of the data to be written in a block of the SSD is identical to the lifecycle group of the data which have been written (e.g., data that are currently stored) into that block. For example, the SSD includes a plurality of blocks in which data may be stored. Before writing data into a particular block of the SSD, which is the block of the SSD to be currently written into, in Step S301 it is determined whether the lifecycle group of the data already stored in the particular block is the same as the lifecycle group of the data to be written into the particular block.

For example, the lifecycle group of the data which are stored in the block to be currently written into may be determined based on the lifecycle group of the data that was last written into the block to be currently written into. In an exemplary embodiment of the inventive concept, it is determined that the lifecycle group of the data which are currently stored in a particular block of the SSD, which is the block of the SSD to be currently written into, is the same as the lifecycle group of the data that was last written into that block. The lifecycle group of the data which are stored in the block to be currently written into belong may also be determined based on the lifecycle group of most of the data that is already stored in the block to be currently written into.

In Step S302, when it is determined that the lifecycle group of the data to be written in the block of the SSD to be currently written into is identical to the lifecycle group of the data which are stored in that block, the data to be written into the SSD are written into a location of the block to be currently written into. This is done to store as much data belonging to the same lifecycle group as possible into the same block of the SSD.

In Step S303, when the lifecycle group of the data to be written is different from the lifecycle group to which the data which are already stored in the block to be currently written into, the data to be written are held in a writing suspend state. For example, the data to be written are not written for the time being because the lifecycle group of the data to be written is different from the lifecycle group of the data already stored in the block to be currently written into.

In an exemplary embodiment of the inventive concept, after Step S303, it may be detected whether there currently are new data to be written which are waiting to be written into the SSD. When there currently are new data to be written which are waiting to be written into the SSD, the method returns to Step S10 and performs the method steps of the method illustrated with reference to FIG. 1 for the new data to be written. When there currently are no new data to be written which are waiting to be written into the SSD, all the data to be written which are held in the suspend state are written into the block to be currently written into of the SSD. For example, the data to be written which are held in the suspend state may start being written in a location to be written of the block to be currently written into. If there currently are new data to be written which are waiting to be written into the SSD, Steps S10-S30 are performed with respect to the new data to be written. If there currently are no new data to be written which are waiting to be written into the SSD, only the data to be written which is held in the suspend state may start being written in a location to be written of the block to be currently written into.

In a process of writing all the data to be written which is held in the suspend state, the data to be written belonging to (e.g., having) the same lifecycle group, among all the data to be written which is held in the suspend state, may be sequentially and successively written into the SSD. The data having the same lifecycle group, from among the data to be written which is held in the suspend state, may start being written in a location to be written of the block to be currently written into. Thus, as much data having the same lifecycle length or deletion time as possible may be stored in the same block.

A method for writing data to be written into an SSD according to an exemplary embodiment of the present inventive concept may further include detecting whether there are data currently being written into the SSD when the data to be written is in a form of a file. In this case, Step S301 is performed when there are no data currently being written into the SSD. When there are data currently being written into the SSD, Step S301 is performed after the writing of data is completed. For example, only when there are no data currently being written into the SSD, Step S301 is performed. This is done to ensure that the data of the same file are consecutively stored in consecutive storage locations in the SSD. Accordingly, as much data having the same lifecycle length or deletion time as possible may be stored in the same block because the data of the same file have the same or similar lifecycle length or deletion time.

The data to be written are written into blocks of the SSD that correspond to the lifecycle group of the data to be written. In an exemplary embodiment of the inventive concept, a block of the SSD corresponds to the lifecycle group of the data to be written in it when the lifecycle group of the data already stored in the block is identical to the lifecycle group of the data to be written into that block. Thus, as much data having the same lifecycle group as possible may be stored in the same block. This may ensure that the data written into a particular block of the SSD belong to the same lifecycle group. Accordingly, the data stored in a particular block of the SSD may have the same and/or similar lifecycle length or deletion time since the data belonging to the same lifecycle group have the same and/or similar lifecycle length or deletion time. Therefore, an amount of valid data needed to be moved can be reduced when performing a garbage collection on the SSD to decrease wear of the SSD, to extend the service life of the SSD and to increase the performance of the SSD.

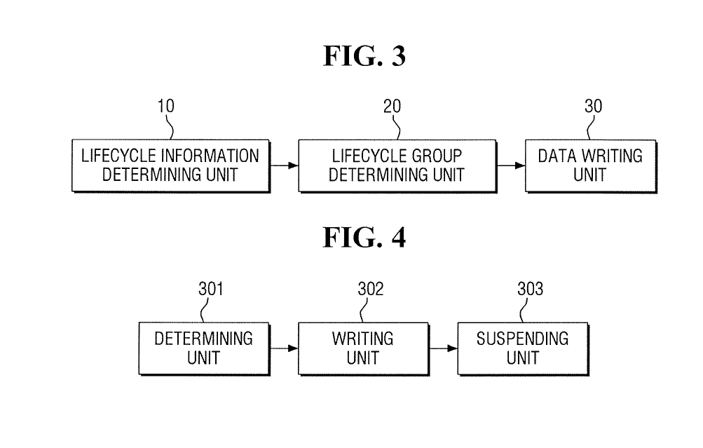

FIG. 3 illustrates a block diagram of an apparatus for writing data to an SSD, according to an exemplary embodiment of the present inventive concept.

As shown in FIG. 3, an apparatus for writing data into an SSD, according to an exemplary embodiment of the present inventive concept includes a lifecycle information determining unit 10, a lifecycle group determining unit 20, and a data writing unit 30.

The lifecycle information determining unit 10 is used to determine lifecycle information of data to be written into the SSD. The data to be written into the SSD may exist in a form of a data unit, for example, a file, a field, a byte, a bit, or other data having various data structures. The inventive concept is not limited to the above-referenced data units and may include other data units in addition to the above-referenced data units. The lifecycle information is information which may indicate a lifecycle length of the data or a deletion time of the data. The lifecycle length of the data may indicate how long the data is stored in the SSD before being updated. The deletion time of the data may indicate how long the data will be stored in the SSD before it gets deleted or a predetermined deletion time of the data. Accordingly, in an exemplary embodiment of the inventive concept, the lifecycle information indicates a storage time length of the data. In an exemplary embodiment of the inventive concept, the lifecycle information indicates a deletion time of the data. The lifecycle information of the data may be determined according to characteristics of the data.

For example, some applications or systems may need to periodically update or delete data. Therefore, the lifecycle information of these data may be quantitatively determined based on the update or deletion period.

In addition, the lifecycle information of the data may also be determined according to a logical storage unit of the data in the SSD. For example, when the logical storage unit is a file, the data belonging to the same file have the same lifecycle information. Accordingly, if a first data and a second data are data of the same file, then it may be determined that the lifecycle information of the first data is identical to the lifecycle information of the second data.

In addition, statistics or a training of various combination relationships between the lifecycle information of the data and an attribute of the data, for example the type of the data, the utility of the data, the source of the data, and the like, may be conducted. Accordingly, it may be possible to qualitatively determine the lifecycle information of the data by using the attributes of the data. The statistics or training of the various combination relationships between the lifecycle information of the data and the attributes of the data may be implemented in cases when a usage scene of the SSD is relatively fixed or repeated.

It should be understood that the lifecycle information of the data may be obtained in various ways. The present inventive concept is not limited to the above-referenced ways of obtaining the lifecycle information of data.

In an exemplary embodiment of the inventive concept, level information of data in a RocksDB system may be used to determine the lifecycle information of the data. For example, in an exemplary embodiment of the inventive concept, the level information of data in the RocksDB system is the lifecycle information of the data. In the RocksDB system, when performing a level compaction, the level compaction is implemented by combining data in two adjacent levels. This is so because the combination involves an operation on most of the data in a level. The data in the same level have the same or similar lifecycle. Most of the data stored in each level have the same or similar deletion time. The deletion time of most of the data stored in a particular level may be obtained by conducting statistics on a generation time and a deletion time of the data stored in the particular level. Therefore, it may be determined that a first data and a second data have the same or similar deletion time when the information of the first and second data indicates that the first and second data belong to the same level. In an exemplary embodiment of the inventive concept, a data type of data in a Cassandra system may be used to determine the lifecycle information of the data. In the Cassandra system, most of the data belong to one of the following three data types: metadata, a log file, and an SST file. The metadata may be frequently updated and may be modified during each database operation. Accordingly, the lifecycle of the metadata may be short. The log file exists for database reliability and may then be deleted after the data are regularly fixed into the SSD from a memory through a storage system. Accordingly, the lifecycle of the data in the log file may be intermediate. An SST file may be used for placement of real data. Accordingly, a lifecycle of the SST file may be long.

In an exemplary embodiment of the inventive concept, information of an object indicated by the data can be used as the lifecycle information of the data. Because the object indicated by the data generally corresponds to a lifecycle length or a deletion time of the data, the lifecycle information of the data may be acquired according to the object indicated by the data. For example, in a storage system for a game management system, when an object indicated by the data is a user ID, user registration information, and the like, and the data may not be updated once created, the lifecycle of data indicating this object is long. When an object indicated by the data is experience of the game player, money of the game player, and the like, the lifecycle of the data indicating this object is short because these data are associated with each game operation and are updated frequently. When an object indicated by the data is a user ranking, and the like, the data may need to be updated hourly or daily. Accordingly, the lifecycle of the data indicating this object is intermediate.

In an exemplary embodiment of the inventive concept, information indicating a source of data may be used to determine the lifecycle information of the data. The lifecycle information of the data may be determined based on the source of the data. In a cloud storage system, for example, data may be divided into data uploaded by a user and internal management data, according to the source of the data. The internal management data, for example, include an index, a distribution path, and the like, and are associated with operations of all users and are frequently updated. Therefore, it may be determined that the lifecycle of the internal management data is short. When the data uploaded by the user are associated only with the user and are infrequently modified by the user, it may be determined that the lifecycle of the data uploaded by the user is long. Alternatively, a lifecycle of data stored by a respective user may be predicted according to operation habits of the user. For example, when the user is accustomed to not modifying the data for a long time after uploading the data, it may be determined that the lifecycles of all the data uploaded by the user are long. When the user is accustomed to frequently modify the data, delete the data, or the like, after uploading the data, it may be determined that the lifecycles of all the data uploaded by the user are short.

It should be understood that other information which can be used to indicate a lifecycle length or a deletion time of data may be used to determine the lifecycle information of the data. The inventive concept is not limited to the above-referenced ways to determine the lifecycle information of data to be written into an SSD.

The lifecycle group determining unit 20 is used to determine a lifecycle group of the data to be written based on the lifecycle information of the data to be written as determined by the lifecycle information determining unit 10.

Here, data that have the same or similar lifecycle information belong to the same lifecycle group. For example, data that have the same or similar lifecycle information are grouped in the same lifecycle group.

For example, when the lifecycle information includes level information of data in a RocksDB system, data that have the same level information are grouped in the same lifecycle group. When the lifecycle information is a data type of the data in a Cassandra system, the data that are of the same data type (e.g., the metadata, the log file, the SST, and the like) are grouped in the same lifecycle group. When the lifecycle information is information of an object indicated by the data, the data that indicate the same object are grouped in the same lifecycle group. When the lifecycle information is the source of the data, the data that come from the same source are grouped in the same lifecycle group.

In addition, when the lifecycle information indicates deletion time, the data of which the deletion time is in the same garbage collection cycle are grouped in the same lifecycle group.

The data writing unit 30 is used to write data to be written into the SSD according to the lifecycle group in which the data to be written are grouped. For example, a writing sequence of the data to be written into the SSD is determined by considering the lifecycle group in which the data to be written are grouped.

In an exemplary embodiment of the inventive concept, an SSD may include a plurality of blocks. Each block, from among the plurality of blocks of the SSD, may correspond to a particular lifecycle group. The data writing unit 30 may write the data to be written into a block of the SSD that corresponds to the lifecycle group of the data to be written. For example, a block of the SSD may to correspond to a first lifecycle group. The first lifecycle group may be, for example, a group for data having a short lifecycle. Data to be written may be grouped into a first group. The first group may be, for example, a group of data that is determined to have a short lifecycle. Accordingly, that data to be written that is grouped into the first group may be written into the first block. This is done to write data having a same lifecycle group in the same block. In addition, the data stored in the same block have the same or similar lifecycle length and/or the same or similar deletion time.

In an exemplary embodiment of the inventive concept, when there is a plurality of data to be written into the SSD, the data writing unit 30 may sequentially and successively write the data to be written which are grouped the same lifecycle group. This is done to store as much data that is grouped in the same lifecycle group as possible into the same block of the SSD. For example, when being written, the data that are grouped in the same lifecycle group are arranged together and written into the SSD sequentially.

The data writing unit 30 may sort a plurality of data to be written according to the lifecycle group in which the data are grouped. For example, data grouped in a first lifecycle group may be sorted first, data belonging to a second lifecycle group may be sorted second, data belonging to a third lifecycle group may be sorted third, and the like. The data writing unit 30 may write the data to be written sequentially and successively into the SSD in the sorted order.

FIG. 4 illustrates a block diagram of a data writing unit, according to an exemplary embodiment of the present inventive concept.

As shown in FIG. 4, a data writing unit 30, according to an exemplary embodiment of the present inventive concept, includes a determining unit 301, a writing unit 302, and a suspending unit 303.

The determining unit 301 is used to determine whether the lifecycle group in which the data to be written are grouped is identical to the lifecycle group of data already stored in a particular block of the SSD. In this case, the particular block of the SSD is the block in which data will currently be written into.

For example, the determining unit 301 may determine the lifecycle group of the data which are already stored in the block to be currently written into based on the lifecycle group to which the data that was last written into that block belongs. In an exemplary embodiment of the inventive concept, the determining unit 301 determines that the lifecycle group of the data which are currently stored in a particular block of the SSD, which is the block of the SSD to be currently written into, is the same as the lifecycle group of the data that was last written into that block. The lifecycle group of the data which are currently stored in a particular block of the SSD, which is the block of the SSD to be currently written into, may also be determined based on the lifecycle group of the majority of the data written into that block. In an exemplary embodiment of the inventive concept, the determining unit 301 determines that the lifecycle group of the data which are currently stored in a particular block of the SSD, which is the block of the SSD to be currently written into, is the same as the lifecycle group of the majority of the data written into that block

The writing unit 302 is used to write the data to be written into the SSD beginning from a location to be written into of the block to be currently written into. The writing unit 302 writes the data to be written into the SSD when the determining unit 301 determines that the lifecycle group of the data to be written (e.g., the lifecycle group in which the data to be written is grouped) is identical to the lifecycle group of the data that is already written into the block to be currently written into. This is done to store as much data that is grouped in the same lifecycle group as possible into the same block of the SSD.

The suspending unit 303 is used to hold the data to be written in a writing suspend state when the determining unit 301 determines that the lifecycle group of the data to be written is different from the lifecycle group of the data that is already stored in the block to be currently written into. When the determining unit 301 determines that the lifecycle group of the data to be written is different from the lifecycle group of the data that is already stored in the block to be currently written into, the suspending unit 303 holds the data to be written in the writing suspend state.

In an exemplary embodiment of the inventive concept, the data writing unit 30 may further include a first detecting unit (not shown). The first detecting unit is used to detect whether there are currently new data to be written which are waiting to be written into the SSD after the suspending unit 303 holds the data to be written in the writing suspend state. When the first detecting unit detects that there are currently new data to be written which are waiting to be written into the SSD, the lifecycle information determining unit 10 determines the lifecycle information of the new data to be written. For example, after data is held in the writing suspend state by the suspending unit 303, the apparatus for writing data into an SSD illustrated with reference to FIG. 3 checks to determine whether there are other data to be written, or new data to be written. The other data to be written, or new data to be written, exclude the data that is being held in the writing suspend state by the suspending unit 303. The other data to be written, or the new data to be written, is processed by the lifecycle information determining unit 10, the lifecycle group determining unit 20, and the data writing unit 30 before the data that is held in the writing suspend state by the suspend unit 303 is written into the SSD. When there currently are no other data to be written, or new data to be written, which are waiting to be written into the SSD, the writing unit 302 writes into the SSD all the data to be written which are held in the writing suspend state by the suspending unit 303 beginning from the location to be written into of the block to be currently written into.

In a process of writing by the writing unit 302, all the data to be written into the SSD which are held in the writing suspend state may be sequentially and successively written into the SSD beginning from a location to be written into of the block to be currently written into. This is so when the data to be written, among all the data to be written which are held in the writing suspend state, belong to the same lifecycle group. This is done to ensure, as much as possible, that the data belonging to the same lifecycle group are adjacently stored in the SSD. Accordingly, as much data having the same lifecycle length or deletion time as possible may be stored in the same block.

In an exemplary embodiment of the inventive concept, the data writing unit 30 may further include a second detecting unit (not shown). The second detecting unit is used to detect whether there are data currently being written into the SSD, when the data to be written is in the form of a file. The determining unit 301 determines whether the lifecycle group of the data to be written is identical to the lifecycle group of the data which are already stored into the block of the SSD to be currently written into. The determining unit 301 does so when the second detecting unit detects that there are no data currently being written into the SSD. When there are data currently being written into the SSD, the determining unit 301 determines whether the lifecycle group of the data to be written is identical to the lifecycle group of the data which are already stored into the block of the SSD to be currently written into. The determining unit 301 does so after the writing of data is completed. Accordingly, only when there are no data currently being written into the SSD, the determining unit 301 determines whether the lifecycle group of the data to be written is identical to the lifecycle group of the data that are already stored into the block of the SSD to be currently written into. This is done to consecutively store data of the same file in consecutive storage locations in the SSD. Since the data of the same file have the same or similar lifecycle length or deletion time, as much data having the same lifecycle length or deletion time as possible may be stored in the same block.

The data writing unit 30 writes the data to be written into blocks of the SSD that correspond to the lifecycle group of the data to be written. This may ensure that the data written into a respective block of the SSD are grouped in the same lifecycle group so as much data having the same lifecycle length or deletion time as possible may be stored in the same block. Therefore, an amount of valid data needed to be moved can be reduced when performing a garbage collection on the SSD to decrease wear of the SSD, to extend the service life of the SSD, and to increase a usage time of the SSD under the same data writing traffic. Accordingly, this may increase the performance of the SSD.

According to an exemplary embodiment of the present inventive concept, the above method can be implemented as a computer program. When the computer program is executed, the above method is implemented. A unit in an apparatus for writing data into the SSD, according to an exemplary embodiment of the present inventive concept, may be implemented as a hardware component. Those skilled in the art may implement the unit, for example, by using a field programmable gate array (FPGA) or an application specific integrated circuit (ASIC) according to a processing performed by the unit. The method and apparatus for writing data into the SSD, according to an exemplary embodiment of the present inventive concept, can write data having the same or similar lifecycle length or deletion time into the same block in the SSD to reduce valid data needed to be moved when performing the garbage collection on the SSD. Accordingly, the performance of the SSD may be increased and the service life of the SSD may be extended.

While the inventive concept has been particularly shown and described with reference to exemplary embodiments thereof, it will be apparent to those of ordinary skill in the art that various changes in form and detail may be made therein without departing from the spirit and scope of the inventive concept.

1. A method for writing data into a solid state disk (SSD), comprising:
determining lifecycle information of data to be written;
determining a lifecycle group of the data to be written based on the lifecycle information of the data to be written; and
writing the data to be written into the SSD based on the lifecycle group of the data to be written.

2. The method of claim 1, wherein the SSD comprises a plurality of blocks that correspond to a plurality of lifecycle groups, and
wherein writing the data to be written into the SSD comprises:
writing the data to be written into a block of the SSD that corresponds to the lifecycle group of the data to be written into the SSD.

3. The method of claim 1, wherein, when there are a plurality of data to be written into the SSD, writing the data to be written into the SSD comprises:
sequentially and successively writing the data having a same lifecycle group, from among the plurality of data to be written into the SSD.

4. The method of claim 1, wherein writing the data to be written into the SSD comprises:
determining whether the lifecycle group of the data to be written into a block of the SSD to be currently written into is identical to the lifecycle group of the data which are stored in the block of the SSD to be currently written into;
when the lifecycle of the data to be written into the block of the SSD to be currently written into is identical to the lifecycle group of the data which is stored in the block of the SSD to be currently written into, writing the data to be written into the block of the SSD to be currently written into by beginning from a location to be written into of the block of the SSD to be currently written into; and
holding the data to be written in a writing suspend state when the lifecycle group of the data to be written in the block of the SSD to be currently written into is different from the lifecycle group of the data which are stored in the block of the SSD to be currently written into.

5. The method of claim 4, wherein writing the data to be written into the SSD further comprises:
detecting whether there are new data to be written into the SSD which are waiting to be written into the SSD after writing the data to be written into the SSD,
wherein, when there are new data to be written which are waiting to be written into the SSD, determining a lifecycle information of the new data to be written into the SSD, and
when there are no new data to be written which are waiting to be written into the SSD, writing into the SSD all the data to be written into the SSD which are held in the writing suspend state beginning from a location to be written into of a block to be currently written into.

6. The method of claim 5, wherein the data to be written into the SSD having a same lifecycle group, from among all the data to be written into the SSD which are held in the writing suspend state, are sequentially and successively written into the SSD during a process of writing all the data to be written into the SSD which are held in the writing suspend state by beginning from the location to be written into of the block to be currently written into.

7. The method of claim 4, wherein the data to be written into the SSD are in a form of a file, and wherein writing the data to be written into the SSD further comprises:
detecting whether there are data currently being written into the SSD,
wherein, when there are no data currently being written into the SSD, it is determined whether the lifecycle group of the data to be written into the block of the SSD to be currently written into is identical to the lifecycle group of the data which is stored in the block of the SSD to be currently written into.

8. The method of claim 1, wherein the lifecycle information of the data to be written into the SSD indicates a lifecycle length or a deletion time of the data to be written into the SSD.

9. The method of claim 8, wherein the data to be written into the SSD of which the deletion time is in a same garbage collection cycle are grouped in a same lifecycle group.

10. The method of claim 1, wherein the data to be written into the SSD having a same or similar lifecycle information are grouped in a same lifecycle group.

11. An apparatus for writing data into a solid state disk (SSD), comprising:
a lifecycle information determining unit to determine lifecycle information of data to be written into the SSD;
a lifecycle group determining unit to determine a lifecycle group of the data to be written into the SSD according to the lifecycle information of the data to be written into the SSD; and
a data writing unit to write the data to be written into the SSD according to the lifecycle group of the data to be written into the SSD.

12. The apparatus of claim 11, wherein a plurality of blocks of the SSD correspond to a plurality of lifecycle groups of the data to be written in the SSD,
wherein the data writing unit writes the data to be written into the SSD into a block of the SSD, from among the plurality of blocks of the SSD, that corresponds to the lifecycle group of the data to be written into the SSD.

13. The apparatus of claim 11, wherein, when there are a plurality of data to be written into the SSD, the data writing unit writes into the SSD the data to be written that are grouped in a same lifecycle group sequentially and successively.

14. The apparatus of claim 11, wherein the data writing unit comprises:
a determining unit to determine whether the lifecycle group of the data to be written into a block of the SSD to be currently written into is identical to the lifecycle group of the data which are stored into the block of the SSD to be currently written into;
a writing unit to write the data to be written into the SSD by beginning from a location to be written into of the block of the SSD to be currently written into, when the lifecycle group of the data to be written into the SSD is identical to the lifecycle group of the data which are stored into the block of the SSD to be currently written into; and
a suspending unit to hold the data to be written in a writing suspend state when the lifecycle group of the data to be written into the block of the SSD to be currently written into is different from the lifecycle group of the data which are stored into the block of the SSD to be currently written into.

15. The apparatus of claim 14, wherein the data writing unit further comprises:
a first detecting unit to detect whether there currently are new data to be written which are waiting to be written into the SSD after holding the data to be written in the writing suspend state,
wherein, when there currently are new data to be written which are waiting to be written into the SSD, the lifecycle information determining unit determines a lifecycle information of the new data to be written, and
when there currently are no new data to be written which are waiting to be written into the SSD, the writing unit writes all the data to be written into the SSD which are held in the writing suspend state by beginning from a location to be written into of a block to be currently written into.

16. The apparatus of claim 15, wherein, during a writing process, the writing unit sequentially and successively writes into the SSD the data to be written into the SSD which are grouped in a same lifecycle group, among all the data to be written into the SSD which are held in the writing suspend state, by beginning from the location to be written into of the block to be currently written into.

17. The apparatus of claim 14, wherein the data to be written into the SSD are in a form of a file, and wherein the data writing unit further comprises:
a second detecting unit to detect whether there are data currently being written into the SSD,
wherein, when there are no data currently being written into the SSD, the determining unit determines whether the lifecycle group of the data to be written into the SSD is identical to the lifecycle group of the data which are stored into the block of the SSD to be currently written into.

18. The apparatus of claim 11, wherein the lifecycle information of the data to be written into the SSD indicates a lifecycle length or a deletion time of the data to be written into the SSD.

19. The apparatus of claim 18, wherein the data to be written in the SSD of which the deletion time is in a same garbage collection cycle are grouped in a same lifecycle group.

20. The apparatus of claim 11, wherein the data to be written into the SSD having the same or similar lifecycle information belong to a same lifecycle group.

21-26. (canceled)
